(19) United States
(12) Patent Application Publication
(10) Pub. No.: US 2010/0326538 A1
(43) Pub. Date: Dec. 30, 2010

(54) Water recirculation system

(76) Inventor: Abdullah Saeed Al-Ghamdi, Jeddah (SA)

Correspondence Address: LITMAN LAW OFFICES, LTD., PATENT LAW BUILDING, 8955 CENTER STREET, MANASSAS, VA, 20110, US

(21) Appl. No.: 12/457,893

(22) Filed: Jun. 24, 2009

(51) Int. Cl. G05D 9/00; E03B 7/00

(52) U.S. Cl. 137/386; 137/563

(57) ABSTRACT

The water recirculation system provides for the controlled recirculation of water between an overhead water tank, which is mounted on the roof of a building, and an underground water tank. The overhead tank has a feed outlet, a recirculation outlet, and a recirculation inlet formed therein. A first conduit is provided, with a lower end thereof being positioned within the underground tank. A pump draws water from within the underground tank, which is delivered to a second conduit. An upper end thereof is in fluid communication with the overhead tank. A third conduit is further provided, having an upper end in communication with the overhead tank and a lower end in communication with the underground tank. A programmable valve selectively controls water flow out of the overhead tank, which is delivered, via the third conduit, to the underground tank by gravity.

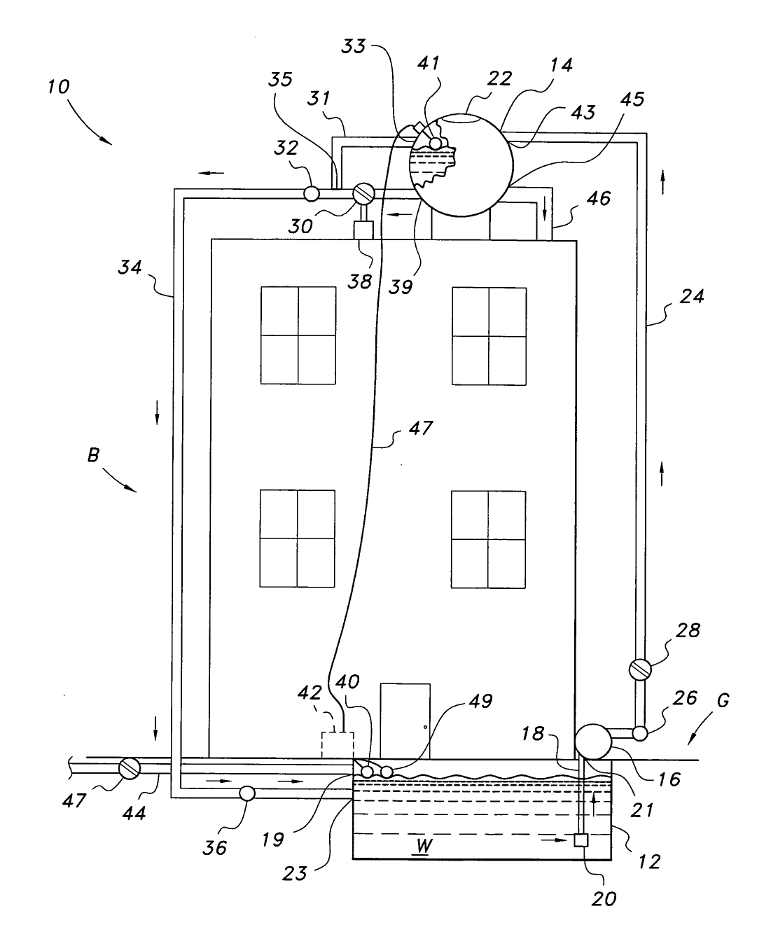

### BACKGROUND OF THE INVENTION

1. Field of the Invention

The present invention relates to water supply systems, and particularly to a water recirculation system, and particularly to a system for recirculating water between an overhead tank mounted on the roof of a building and an underground tank.

2. Description of the Related Art

In regions where intermittent water supply systems are used, water is typically stored in buildings in underground tanks (for use during pumping periods) and in overhead tanks. Such regions are typically divided into a number of small sectors, and water is pumped from the public water supply to each sector, based on a rotating schedule. The period between water pumping cycles for a given region may be several days or even weeks. The water is stored in the underground tank (usually greater than 50 cubic meter capacity) between pumping periods. The overhead tank typically has enough capacity (usually about 2-6 cubic meters) to supply enough head to furnish water pressure to the building. Water is pumped from the underground tank to the overhead tank as needed to maintain head, depending upon water usage in the building.

Normal use of the plumbing allows the water to circulate between the tanks, thus preventing stagnation of the water. However, during vacation seasons or holidays, water usage in the building may be very low while the building occupants are away, thus preventing proper circulation of water between the overhead and underground tanks, leading to stagnation of the water.

Such stagnation may result in the growth of bacteria, algae and the like within both tanks, thus polluting and contaminating the water supply, which is not regularly refreshed by the public water supply. Thus, a water recirculation system solving the aforementioned problems is desired.

### SUMMARY OF THE INVENTION

The water recirculation system provides for the controlled recirculation of water between an overhead water tank, which is mounted on the roof of a building, and an underground water tank. The overhead tank is adapted for storing water therein. The overhead tank has a feed outlet, a recirculation outlet and a recirculation inlet formed therein.

A first conduit having opposed upper and lower open ends is provided. The lower end of the first conduit is positioned within the water stored in the underground tank. A pump that is in fluid communication with the upper end of the first conduit, which passes through a recirculation outlet formed through the underground tank, selectively draws water from within the underground tank. This water is then delivered to a second conduit, also having opposed upper and lower open ends. The lower end of the second conduit is in fluid communication with the pump, and the upper end thereof is in fluid communication with the recirculation inlet of the overhead tank. The underground tank has a water feed inlet adapted for connection with an external water supply and a recirculation inlet formed therein.

A third conduit having opposed upper and lower open ends is provided. The upper end of the third conduit is in fluid communication with the recirculation outlet of the overhead tank, and the lower end is in fluid communication with the recirculation inlet of the underground tank. A programmable valve selectively controls water flow out of the overhead tank, which is delivered, via the third conduit, to the underground tank by gravity. Preferably, the programmable valve includes a timer for automatically controlled release of the water, under a user-programmable schedule.

Additionally, a controller is preferably provided for selectively actuating the pump. The controller preferably includes a water level sensor mounted within the overhead tank so that the pump can be activated if the water level in the overhead tank falls below a set threshold level.

These and other features of the present invention will become readily apparent upon further review of the following specification and drawings.

### BRIEF DESCRIPTION OF THE DRAWINGS

The sole FIGURE is a diagrammatic view of a water recirculation system according to the present invention.

### DETAILED DESCRIPTION OF THE PREFERRED EMBODIMENTS

Referring to the sole drawing FIGURE, the water recirculation system 10 provides for the controlled recirculation of water between an overhead water tank 14, which is mounted on the roof of a building B, and an underground water tank 12, which is located beneath ground level G. The overhead tank 14 and the underground tank 12 are conventional, and are adapted for storing water therein. It should be understood that building B is shown for exemplary purposes only. Further, it should be understood that tanks 12, 14 are shown diagrammatically for exemplary purposes only, and that tanks 12, 14 may have any suitable configuration, depending upon the needed storage capacity and locations thereof.

The overhead tank 14 has a feed outlet 45, a recirculation outlet 39 and a recirculation inlet 43 formed therein. A bypass recirculation outlet 33 is also formed therethrough, for connection to a bypass pipe 31, as will be described in greater detail below. An inspection cover 22 may be mounted over an open upper end of the tank 14. The feed outlet 45 feeds water into the building via a conduit 46, which may branch off to provide multiple water supplies for the various units (apartments, offices, etc.) within building B, as is conventionally known. Water may feed through conduit 46 under the force of gravity alone, or with the aid of a water pump or the like.

A first conduit 18 (for example, 1-inch diameter PVC pipe), having opposed upper and lower open ends, is provided, with the lower end of the conduit 18 being positioned within the water W stored in the underground tank 12. The lower open end may be covered with a water filter 20 or other suitable filter or purifying device. A pump 16 is in fluid communication with the upper end of the first conduit 18, which passes through a recirculation outlet 21 formed through the underground tank 12. Pump 16 may be any suitable type of controllable and selectively actuable water pump. Pump 16 is shown as being mounted on the ground G, directly above underground tank 12, although it should be understood that pump 16 may be positioned at any suitable point along the flow path.

Pump 16 selectively draws water W from within the underground tank 12. The water W is delivered to a second conduit 24 (for example, 1-inch diameter PVC pipe), also having opposed upper and lower open ends. The lower end of conduit 24 is in fluid communication with the pump 16, and the upper end of conduit 24 is in fluid communication with the recirculation inlet 43 of the overhead tank 14. The underground tank 12 has a water feed inlet 19 adapted for connection with an external water supply, fed by line 44, which may be connected to the public or municipal water supply. A recirculation inlet 23 is formed through underground tank 12. As shown, flow control valve 47 regulates the pressurized flow within line 44, and is coupled with a float valve 49, mounted within underground tank 12, to close the feed through line 44 if underground tank 12 is full.

A flow control valve 26 is preferably positioned within the second conduit 24, allowing the user to selectively control the rate of water flow therein. A one-way check valve 28 is also preferably positioned within conduit 24, preventing water from flowing down from the overhead tank back into the underground tank (and further preventing accidental damage to pump 16).

A third conduit 34 (for example, 2-inch diameter PVC pipe), having opposed upper and lower open ends, is provided. The upper end of the third conduit 34 is in fluid communication with the recirculation outlet 39 of the overhead tank 14, and the lower end of the third conduit 34 is in fluid communication with the recirculation inlet 23 of the underground tank 12. A programmable valve 30 selectively controls water flow out of the overhead tank 14, which is delivered by the third conduit 34 to the underground tank 12 by gravity. Preferably, the programmable valve 30 includes a programmable timer 38 for timed release of the water under a user-programmable schedule. As will be described in greater detail below, a bypass pipe 31 is further provided, extending between bypass recirculation outlet 33 and junction 35, allowing flow from tank 14 to bypass valve 30.

A flow control valve 32, similar to flow control valve 26, is preferably provided within third conduit 34, providing user control over the rate of water flow through third conduit 34. An auxiliary flow control valve 36 may be provided underground adjacent the water inlet 23, providing redundancy in the water flow control. Additionally, a bypass conduit 31 leads directly from overhead tank 14 to third conduit 34, bypassing programmable valve 30. As shown, bypass recirculation outlet 33 is formed through overhead tank 14, preferably at or above the level of float 41, with bypass conduit 31 extending from port 33 and joining third conduit 34 at 35. In case of float failure, conduit 31 will take the access water by gravity to the underground tank 12 via third conduit 34, without passing through valve 30. Thus, valve 30 only operates according to the user-programmable schedule, rather than being controlled by the water levels in overhead tank 14 or underground tank 12.

A controller 42 is preferably provided for selectively actuating the pump 16. Controller 42 may be a programmable logic controller or any other suitable type of programmable control system. The controller 42 preferably is in communication with a water level sensor, such as exemplary float switch 41, mounted within the overhead tank 14, so that the pump 16 can be activated if the water level in the overhead tank 14 falls below a pre-set threshold level. Float switch 41 is shown in communication with controller 42 via line 47, although it should be understood that any suitable wireless or wired communication may be utilized. Further, it should be understood that controller 42 may be located at any suitable location. Similarly, a float switch 40 may be mounted within underground tank 12, with float switch 40 also being in communication with controller 42.

It should be understood that first, second and third conduits 18, 24, 34 are shown diagrammatically for exemplary purposes only, and that any suitable types of pipes or the like may be utilized, depending upon the nature of building B, the positioning of tanks 12, 14 and the volume and rate of water flow therein. Similarly, flow control valves 26, 32, 36 may be any suitable type of valves, providing user-control over the flow rate of water within the conduits. Further, it should be understood that one-way check valve 28 may be any suitable type of one-way valve, and that programmable valve 30 may be any suitable type of programmable valve coupled with any suitable type of programmable timing circuit. Timer 38 and programmable valve 30 are in electrical communication with controller 42 and pump 16, thus allowing timer 38 to primarily control actuation of pump 16 and release of valve 30, with controller 42 serving as a safety backup system in the event of a water level within tanks 12, 14 being either too high or too low.

As described above, in regions where intermittent water supply systems are utilized, particularly during vacation seasons or holidays, water usage in a building or household may be very low, thus preventing proper circulation of water between the overhead and underground tanks, leading to stagnation of the water. When the building occupants anticipate being absent for an extended period of time, the timer 38 may be programmed to circulate the water every day at a set time, for example, thus allowing frequent recirculation of the water, preventing stagnation. Overhead tank 14 provides water pressure for the interior water supply (via line 46). Preferably, the timer 38 may be set so that overhead tank 14 is drained for approximately ten minutes every twelve hours when a resident is away, for example. Float sensor 41 measures the water level within the overhead tank 14 and delivers measurement signals to controller 42.

If the measured water level within overhead tank 14 drops below a pre-set threshold, there will be insufficient water pressure for the interior sinks, toilets, etc. When controller 42 determines that the measured water level within overhead tank 14 has dropped below the pre-set threshold, valve 30 is closed (if open) to prevent further water loss, and pump 16 is actuated to draw water from underground tank 12 to fill the overhead tank 14 until float sensor 41 measures a sufficient water level within overhead tank 14. Once a maximum, pre-set threshold level has been reached within overhead tank 14, controller 42 deactivates pump 16. As a further alternative, bypass conduit 31 is provided so that if float sensor 41 fails, or if there is a failure in the programmable valve 30, valve 30 is bypassed, allowing water to drain from overhead tank 14 into underground tank 12 via pipe 34, thus preventing accidental overfilling of overhead tank 14.

Communication with float sensor 40 within the underground tank 12 allows controller 42 to send similar control signals to pump 16, thus preventing accidental overfilling of underground tank 12. Float sensor 40 further allows for the measurement of water provided by the municipal water supply via line 44, and further allows for the balance of water pressure between overhead tank 14 and underground tank 12, thus acting as an additional safety measure.

It is to be understood that the present invention is not limited to the embodiment described above, but encompasses any and all embodiments within the scope of the following claims.

I claim:

1. A water recirculation system, comprising:
an overhead tank adapted for mounting on a roof of a building, the overhead tank being adapted for storing water therein, the overhead tank having a feed outlet, a recirculation outlet, and a recirculation inlet formed therein;
means for delivering the water from the overhead tank to the building, the means for delivering being connected to the feed outlet;
an underground tank adapted for storing water therein, the underground tank having a water feed inlet adapted for connection with an external water supply, a recirculation inlet and a recirculation outlet formed therein;
means for selectively supplying the water from the underground tank to the overhead tank, the means for selectively supplying being connected with the recirculation inlet of the overhead tank and the recirculation outlet of the underground tank; and
means for selectively recirculating the water from the overhead tank to the underground tank, the means for selectively recirculating being connected with the recirculation outlet of the overhead tank and the recirculation inlet of the underground tank.

2. The water recirculation system as recited in claim 1, wherein said means for selectively supplying the water from said underground tank to said overhead tank comprises:
a first conduit having opposed upper and lower open ends, the lower end thereof being positioned within the water stored in the underground tank;
a pump in fluid communication with the upper end of the first conduit; and
a second conduit having opposed upper and lower open ends, the lower end thereof being in fluid communication with the pump, the upper end thereof being in fluid communication with the recirculation inlet of the overhead tank.

3. The water recirculation system as recited in claim 2, further comprising a flow control valve disposed in the second conduit for selectively controlling rate of water flow within the second conduit.

4. The water recirculation system as recited in claim 3, further comprising a one-way check valve disposed in the second conduit for preventing backflow in the second conduit from the overhead tank to the underground tank.

5. The water recirculation system as recited in claim 4, further comprising a filter mounted on the open lower end of the first conduit.

6. The water recirculation system as recited in claim 4, wherein said means for selectively recirculating the water from said overhead tank to said underground tank comprises:
a third conduit having opposed upper and lower open ends, the upper end thereof being in fluid communication with the recirculation outlet of the overhead tank, the lower end thereof being in fluid communication with the recirculation inlet of the underground tank; and
a programmable valve disposed in the third conduit.

7. The water recirculation system as recited in claim 6, wherein the programmable valve includes a programmable timer.

8. The water recirculation system as recited in claim 7, further comprising at least one flow control valve for selectively controlling rate of water flow within the third conduit.

9. The water recirculation system as recited in claim 8, wherein said timer is configured for selectively actuating the programmable valve according to a programmable schedule to recirculate the water from the overhead tank to the underground tank at selected times for selected time intervals.

10. The water recirculation system as recited in claim 9, further comprising a water level sensor disposed in the overhead tank and means for selectively actuating the pump to pump water from the underground tank to the overhead tank when the sensor signals that the water in the overhead tank has fallen below a predetermined threshold limit.

11. The water recirculation system as recited in claim 10, wherein the water level sensor is a float sensor positioned within the overhead tank.

12. A water recirculation system, comprising:
an overhead tank adapted for mounting on a roof of a building, the overhead tank being adapted for storing water therein, the overhead tank having a feed outlet, a recirculation outlet, and a recirculation inlet formed therein;
means for delivering the water from the overhead tank to the building, the means for delivering being connected to the feed outlet of the overhead tank;
an underground tank adapted for storing the water therein, the underground tank having a water feed inlet adapted for connection with an external water supply, a recirculation inlet, and a recirculation outlet formed therein;
means for selectively supplying the water from the underground tank to the overhead tank, the means for supplying being connected to the recirculation inlet of the overhead tank and the recirculation outlet of the underground tank;
means for selectively recirculating the water from the overhead tank to the underground tank, the means for recirculating being connected to the recirculation outlet of the overhead tank and the recirculation inlet of the underground tank; and
means for measuring a level of the water stored in the overhead tank and for selectively actuating the means for selectively supplying the water from the underground tank to the overhead tank when the water level in the overhead tank falls below a threshold level.

13. The water recirculation system as recited in claim 12, wherein said means for selectively supplying the water from said underground tank to said overhead tank comprises:
a first conduit having opposed upper and lower open ends, the lower end thereof being positioned within the water stored in the underground tank;
a pump in fluid communication with the upper end of the first conduit; and
a second conduit having opposed upper and lower open ends, the lower end being connected to the pump, the upper end being connected to the recirculation inlet of the overhead tank.

14. The water recirculation system as recited in claim 13, further comprising a flow control valve disposed in the second conduit for selectively controlling rate of water flow within the second conduit.

15. The water recirculation system as recited in claim 14, further comprising a one-way check valve disposed in the second conduit for preventing backflow of the water from the overhead tank to the underground tank.

16. The water recirculation system as recited in claim 15, further comprising a filter mounted on the open lower end of the first conduit.

17. The water recirculation system as recited in claim 15, wherein said means for selectively recirculating the water from said overhead tank to said underground tank comprises:
a third conduit having opposed upper and lower open ends, the upper end being connected to the recirculation outlet of the overhead tank, the lower end being connected to the recirculation inlet of the underground tank; and
a programmable valve disposed in the third conduit.

18. The water recirculation system as recited in claim 17, wherein the means for recirculating further comprises a programmable timer connected to the programmable valve, the programmable timer being configured for opening the programmable valve at selectable times for selectable time intervals in order to recirculate the water from the overhead tank to the underground tank.

19. The water recirculation system as recited in claim 18, further comprising at least one flow control valve disposed in the third conduit for selectively controlling rate of water flow within the third conduit.

20. The water recirculation system as recited in claim 19, wherein said means for measuring a level of the water stored in the overhead tank comprises a float sensor mounted within the overhead tank.
